(19) United States
(12) Patent Application Publication
(10) Pub. No.: US 2026/0072620 A1
(43) Pub. Date: Mar. 12, 2026

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Yuki Nakatani, Chiba (JP); Yukihiro Shindo, Chiba (JP); Takumi Kimura, Chiba (JP); Michihiko Yamada, Ibaraki (JP); Hidekazu Nakashio, Saitama (JP)

(21) Appl. No.: 19/315,990

(22) Filed: Sep. 2, 2025

(30) Foreign Application Priority Data
Sep. 9, 2024 (JP) 2024-155134
Nov. 11, 2024 (JP) 2024-196927

(51) Int. Cl. G06F 3/12; H04N 1/00; H04N 1/60

(52) U.S. Cl. CPC G06F 3/1204; G06F 3/1208; G06F 3/1256; H04N 1/00448; H04N 1/603

(57) ABSTRACT

An information processing apparatus comprises an obtaining unit configured to obtain a production set that includes a plurality of print targets and print settings for the print targets, a generation unit configured to generate a preview image for each print target in the production set based on print settings for that print target, and a display control unit configured to cause preview images generated by the generation unit to be displayed in a list.

### BACKGROUND

### Field of the Technology

The present disclosure relates to a technique for displaying an image.

### Description of the Related Art

To express the worldview of a brand or the like, a unified design may be applied across a plurality of different items, such as advertising media, promotional materials, and products. Such commercial materials with identical designs are called collaterals. When creating collaterals, a plurality of kinds of printers may be used to print the collaterals on various media. At this time, one of the important quality items is to align the color impressions regardless of the printer or the media. To realize printing with aligned color impressions, it is important that a preview in which the printed colors of the content are accurately reproduced be displayed and confirmed on a monitor in advance.

Japanese Patent Laid-Open No. 2010-286998 discloses a technique for generating preview image data of print data for each printer based on characteristic information of each printer and displaying a list of preview image data.

However, in Japanese Patent Laid-Open No. 2010-286998 described above, preview images are created only for the same image, so previews of a plurality of different images cannot be displayed.

### SUMMARY

The present disclosure provides a technique that allows an image in which the printed colors of a plurality of print targets are accurately reproduced to be displayed without complicated operations.

According to the first aspect of the present disclosure, there is provided an information processing apparatus comprising: an obtaining unit configured to obtain a production set that includes a plurality of print targets and print settings for the print targets; a generation unit configured to generate a preview image for each print target in the production set based on print settings for that print target; and a display control unit configured to cause preview images generated by the generation unit to be displayed in a list.

According to the second aspect of the present disclosure, there is provided an information processing method performed by an information processing apparatus, the method comprising: obtaining a production set that includes a plurality of print targets and print settings for the print targets; generating a preview image for each print target in the production set based on print settings for that print target; and causing the preview image generated for each print target to be displayed in a list.

According to the third aspect of the present disclosure, there is provided a non-transitory computer-readable storage medium storing a computer program for causing a computer to function as: an obtaining unit configured to obtain a production set that includes a plurality of print targets and print settings for the print targets; a generation unit configured to generate a preview image for each print target in the production set based on print settings for that print target; and a display control unit configured to cause preview images generated by the generation unit to be displayed in a list.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an example of a configuration of a color impression consistency prioritizing printing system.

FIG. 2 is a block diagram illustrating an example of a configuration of a printed color list preview system.

FIG. 3 is a flowchart of processing performed by the printed color list preview system.

FIG. 4A is a diagram illustrating an example of a configuration of a production set 400.

FIG. 4B is a diagram illustrating an example of a configuration of print setting data 403.

FIG. 5 is a schematic diagram illustrating processing for generating a preview image.

FIG. 6 is a diagram illustrating an example of an application screen.

FIG. 7 is a diagram illustrating an example of an application screen.

FIG. 8 is a diagram illustrating examples of an application screen.

FIG. 9 is a flowchart of processing performed by the printed color list preview system.

FIG. 10A is a diagram illustrating an example of an application screen.

FIG. 10B is a diagram illustrating an example of a color adjustment dialog.

FIG. 11 is a block diagram illustrating an example of a configuration of a printed color list preview system.

FIG. 12A is a diagram illustrating an example of an application screen.

FIG. 12B is a diagram illustrating an example of a target color adjustment dialog screen.

FIG. 13 is a block diagram illustrating an example of a configuration of the printed color list preview system.

FIG. 14A is a schematic diagram illustrating a target color and color gamuts of printers and adjustment of the target color.

FIG. 14B is a schematic diagram illustrating a target color and color gamuts of printers and adjustment of the target color.

FIG. 14C is a schematic diagram illustrating a target color and color gamuts of printers and adjustment of the target color.

FIG. 15 is a block diagram illustrating an example of a hardware configuration of a computer apparatus.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

First, the term “original data” (sometimes referred to as “content”) used in the present embodiment and later will be described. In the following description, “original data” is “input digital data to be processed” and is one or more pages of data.

When the original data is one page of data, the original data may be an image that describes the contents of the page or a drawing command group that describes the contents of the page. When the original data is a drawing command group that describes the contents of one page, an image of the page may be rendered based on the drawing command group, and the rendered image may then be processed. The same applies even if the original data is a drawing command group that describes the contents of a plurality of pages, and images of the plurality of pages may be rendered based on the drawing command group, and the rendered image of each page may then be processed.

Further, when the original data is a drawing command group that describes the contents of one page, color processing may be performed on an image rendered based on the drawing command group or on color information included in the drawing command group.

An image is a two-dimensional array of pixels, and each pixel holds information indicating a color in a defined color space. The information indicating a color includes RGB values, CMYK values, K values, CIE-L*a*b* values, LCH values, HSV values, HLS values, and the like.

### <Color Impression Consistency Prioritizing Printing System>

When printing a plurality of pieces of content with identical designs in a plurality of different printing systems (including an application, a printer, and a printing medium such as paper), in order to print the colors to be printed so as to appear consistent with the target color across the printing systems (perform printing that prioritizes impression consistency with the target color), it is necessary to perform appropriate color settings and printer color adjustments for each printer, which may have different color gamuts. That is, a high level of knowledge and skill in color and in each printing system is required. Further, when printing a plurality of pieces of content with identical designs on a plurality of commercial materials, it is generally not feasible for only one printing company to handle it, so a plurality of printing companies are used. In that case, since color adjustments are applied based on each printing company's quality control before printing is performed, it is difficult for a printing client to make a request that prioritizes color consistency.

Therefore, the present embodiment provides a system that allows printing that prioritizes color impression consistency (color impression consistency prioritizing printing system) even if the level of knowledge and skill in individual printing systems is not sufficiently high.

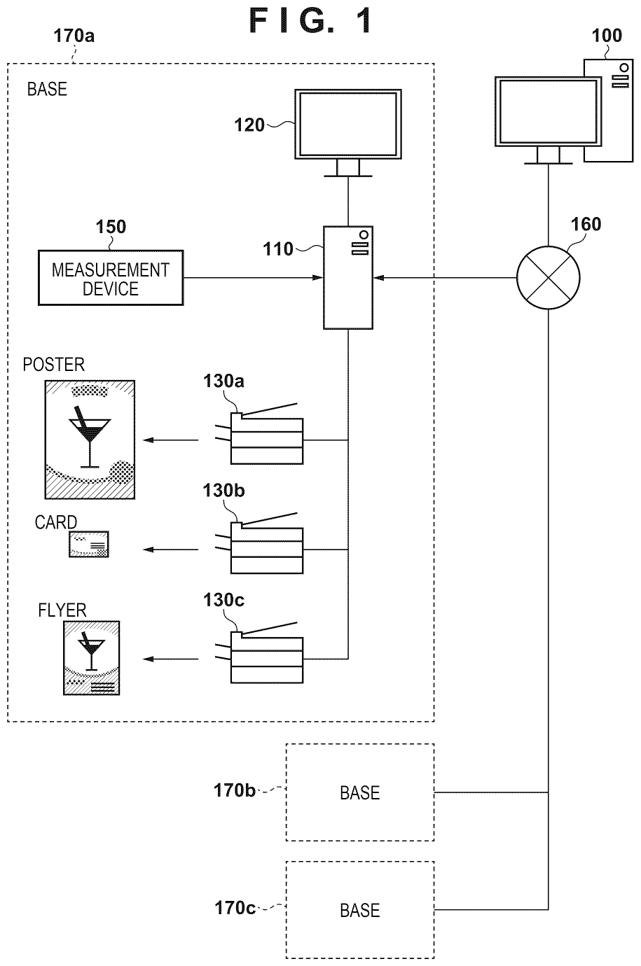

An example of a configuration of a color impression consistency prioritizing printing system according to the present embodiment will be described with reference to FIG. 1. In the color impression consistency prioritizing printing system, a job issuance apparatus 100 and bases 170a, 170b, and 170c are connected via a network 160.

The network 160 is, for example, a local area network (LAN), the Internet, an intranet, or the like. The network 160 may be a wired network, a wireless network, or a network that includes a wired network and a wireless network.

The bases 170a to 170c correspond to locations or the like of printing companies where printers are installed. For example, the base 170a corresponds to a printing base in Tokyo, the base 170b corresponds to a printing base in Osaka, and the base 170c corresponds to a printing base in Fukuoka.

The base 170a includes a control apparatus 110, a monitor 120, printers 130a to 130c, and a measurement device 150. In the present embodiment, for simplicity of description, the bases 170b and 170c are assumed to similarly include the control apparatus 110, the monitor 120, the printers 130a to 130c, and the measurement device 150. However, the system configuration does not necessarily have to be the same at all bases and may be different for each base as long as the system has a configuration that can execute processing, such as printing, based on a job transmitted (issued) from the job issuance apparatus 100. In the following, the base 170a will be described as an example among the bases 170a, 170b, and 170c, but the description can similarly be applied to the bases 170b and 170c.

The job issuance apparatus 100 is connected to the control apparatus 110 via the network 160 so as to be capable of mutual communication. The job issuance apparatus 100 performs a color setting for printing that prioritizes impression consistency with the target color (color impression consistency prioritizing setting) for one or more pieces of content or jobs, and generates a job that instructs printing of the content based on the color setting. Then, the job issuance apparatus 100 transmits the generated job to the control apparatus 110.

The job issuance apparatus 100 can generate a job such as an application-based design generation job, a job for submission to a printing company, a monitor color proofing job for a printing company, or a print job for a printer, as a job. In the following, a case where the job issuance apparatus 100 generates a print job as a job and transmits it to the control apparatus 110 will be described.

When the color impression consistency prioritizing setting is set, the control apparatus 110 generates a color profile that prioritizes color impression consistency from two or more pieces of information among content, a target color, and a printer profile, which correspond to the print job received from the job issuance apparatus 100. Then, the control apparatus 110 sets the generated color profile that prioritizes color impression consistency as a color impression consistency prioritizing profile, and includes the color impression consistency prioritizing profile in the content or the print job.

The control apparatus 110 is connected to the measurement device 150, which is at the base 170a, via a communication network, such as a USB cable or an intranet, so as to be capable of mutual communication, and controls the operation of the measurement device 150 and obtains measurement data outputted from the measurement device 150.

The monitor 120 is connected to the control apparatus 110. The monitor 120 includes a liquid crystal screen and a touch panel screen, and can display various user interface screens (UI screens) generated by the control apparatus 110.

Further, the control apparatus 110 is connected to the printers 130a to 130c via a communication network, such as an intranet, so as to be capable of mutual communication, and obtains device information of each printer and instructs each printer to print content based on a print job. The device information of the printer includes information such as paper information and a printer profile.

The printers 130a to 130c print images on print media such as paper, based on print jobs from the control apparatus 110 by using, for example, an electrophotographic processing technique. The printers 130a, 130b, and 130c may be color printers or monochrome printers. Further, the printers 130a, 130b, and 130c may be printers based on another image forming technique, such as inkjet.

The printers 130a, 130b, and 130c are an example of a printing apparatus, and a multifunction peripheral that includes a copy function, a FAX function, and the like in addition to a print function may be applied to the printing apparatus.

The measurement device 150 is a spectrometer that measures a color value of a measurement target based on the reflectance or transmittance of visible light, which has a wavelength from about 400 nm to 700 nm. The measurement device 150, for example, is provided at each base, and measures each color patch on print mediums on which charts (including a plurality of color patches) have been printed by the printers 130a, 130b, and 130c, converts a wavelength obtained for each patch by the measurement into a value in, for example, an L*a*b* color space or an XYZ color space, and outputs data of the converted values as measurement data.

### <Printed Color List Preview System>

To create a plurality of pieces of content with identical designs and in which color impression consistency is prioritized across a plurality of different printing systems, it is important to accurately reproduce and confirm the printed colors of each printer, which may have different color gamuts, on a monitor in advance.

Accordingly, the present embodiment provides a printed color list preview system that allows the display of an accurate preview of printed colors of a plurality of different printing systems without requiring a high level of knowledge and skill in printing systems and color management. In the present embodiment, a case where the printed color list preview system is implemented by the control apparatus 110 will be described, but the printed color list preview system may be implemented in another apparatus (which may include apparatuses not illustrated) in the base 170a.

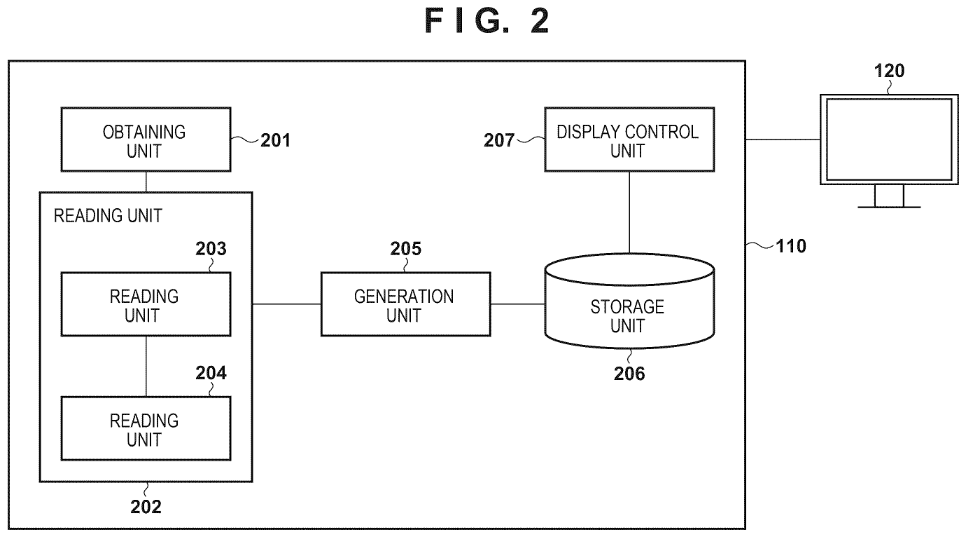

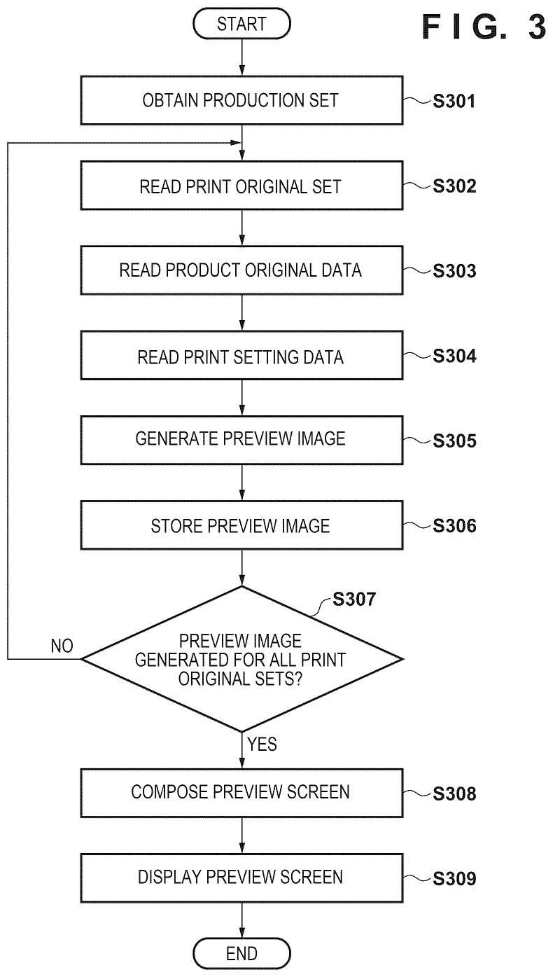

An example of a configuration of a printed color list preview system is illustrated in a block diagram of FIG. 2. The processing performed by the printed color list preview system in order to generate preview images in which printed colors of each piece of content are simulated and display them in a list when printing a plurality of pieces of content with identical designs in a plurality of different printing systems will be described in accordance with a flowchart of FIG. 3.

In step S301, an obtaining unit 201 obtains a production set designated by a user. In the following description, user operations such as designation and selection by the user may be performed by the user operating an operation unit not illustrated (keyboard, mouse, etc.), and when the monitor 120 includes a touch panel screen, may be performed by the user operating the touch panel screen, and are not limited to a specific form.

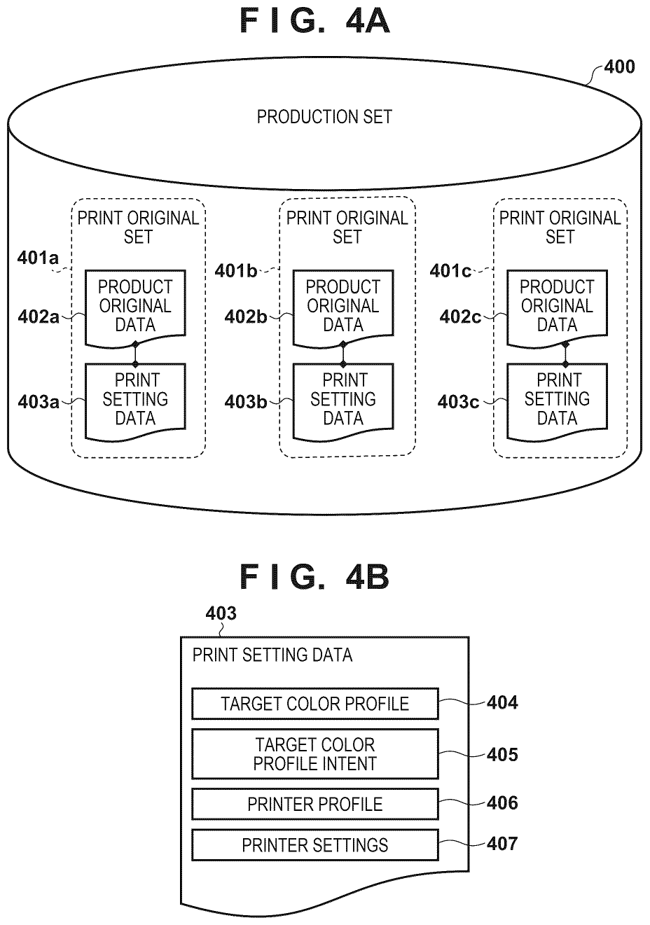

An example of a configuration of a production set is illustrated in FIG. 4A. A production set 400 illustrated in FIG. 4A includes print original sets 401a, 401b, and 401c. Each of the print original sets 401a, 401b, and 401c is a data set that includes content and print settings for the content.

The print original set 401a includes product original data 402a, which is content data, and print setting data 403a, which is data for print settings for the content. The print original set 401b includes product original data 402b, which is content data, and print setting data 403b, which is data for print settings for the content. The print original set 401c includes product original data 402c, which is content data, and print setting data 403c, which is data for print settings for the content.

In the following, when a common description is given for the print original sets 401a, 401b, and 401c, they will be referred to as the print original set 401. Similarly, when a common description is given for the product original data 402a, 402b, and 402c, they will be referred to as the product original data 402. Similarly, when a common description is given for the print setting data 403a, 403b, and 403c, they will be referred to as the print setting data 403. An example of a configuration of the print setting data 403 is illustrated in FIG. 4B.

A target color profile 404 includes input/output color space mapping, as well as white point and black point information, and the like, and is provided, for example, as an ICC profile. A target color profile intent 405 is a setting item indicating a mapping rule in input/output color space mapping, and an ICC profile typically has four types: Perceptual, Saturation, Absolute Colorimetric, and Relative Colorimetric.

A printer profile 406 is a profile of a printer that prints an image based on the product original data 402, and is generally determined by a combination of a printer and a print medium and is provided as, for example, an ICC profile.

Printer settings 407 include information on settings (e.g., paper size, print orientation, print quality, etc.) for a printing medium in a printer that prints an image based on the product original data 402.

In the following description, a case where the target color profile 404 and the printer profile 406 are ICC profiles will be described. In the printing system that prioritizes impression consistency in identical designs, the target color profile 404 and the target color profile intent 405 can be the same in the print original sets 401a to 401c. In the following description, a case where the obtaining unit 201 obtains the production set 400 of FIG. 4A in step S301 will be described as an example.

In step S302, a reading unit 202 obtains the print original set 401 from the production set 400 obtained in step S301. In step S303, a reading unit 203 obtains the product original data 402 from the print original set 401 obtained by the reading unit 202 in step S302. In step S304, a reading unit 204 obtains the print setting data 403 from the print original set 401 obtained by the reading unit 202 in step S302.

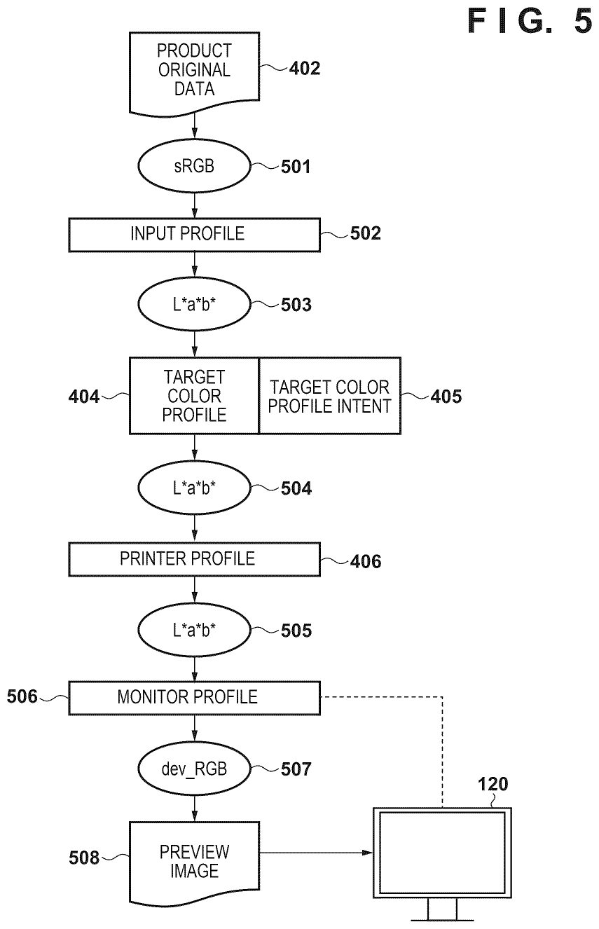

In step S305, a generation unit 205 generates preview images for content corresponding to respective print original sets 401a, 401b, and 401c obtained from the production set 400. The processing for generating a preview image will be described with reference to a schematic diagram of FIG. 5.

In the following description, a case where the product original data 402 is an sRGB image will be described, but the product original data 402 is not limited thereto, and for example, may be an AdobeRGB or CMYK image.

The generation unit 205 converts pixel values sRGB 501 of an sRGB image, which is the product original data 402, into pixel values L*a*b* 503 by using an input profile 502. The input profile 502 is, for example, a profile included in the product original data 402.

Next, the generation unit 205 converts the pixel values L*a*b* 503 into pixel values L*a*b* 504 by using the target color profile 404. At this time, the profile is converted based on the intent designated by the target color profile intent 405.

Next, the generation unit 205 converts the pixel values L*a*b* 504 into pixel values L*a*b* 505 by using the printer profile 406. In the present embodiment, which prioritizes color impression consistency, a profile can be converted based on an Absolute Colorimetric intent.

Next, the generation unit 205 converts the pixel values L*a*b* 505 into device RGB pixel values 507 by using a monitor profile 506 to obtain a preview image 508, which is an image that has the device RGB pixel values 507. Here, the monitor profile 506 is a profile that indicates the display characteristics of the monitor 120, and is generated in advance by a measurement device or the like (not illustrated).

For example, it is assumed that printing based on the print original set 401a is performed in the printer 130a, printing based on the print original set 401b is performed in the printer 130b, and printing based on the print original set 401c is performed in the printer 130c. In this case, a preview image based on the profile of the printer 130a is generated for the print original set 401a. Further, a preview image based on the profile of the printer 130b is generated for the print original set 401b. Further, a preview image based on the profile of the printer 130c is generated for the print original set 401c.

In step S306, the generation unit 205 stores the preview image (preview image corresponding to the print original set 401 obtained in step S302) generated in step S305 in a storage unit 206.

In step S307, the reading unit 202 determines whether a preview image has been generated for all the print original sets 401 included in the production set 400 obtained in step S301.

As a result of this determination, if a preview image has been generated for all the print original sets 401 included in the production set 400 obtained in step S301, the processing proceeds to step S308. Meanwhile, if a print original set 401 for which a preview image has not yet been generated remains among the print original sets 401 included in the production set 400 obtained in step S301, the processing proceeds to step S302. Then, from step S302, similar processing is performed on the print original set 401 for which a preview image has not yet been generated, and a preview image corresponding to the print original set 401 is generated.

In step S308, a display control unit 207 reads out the preview images generated for all the print original sets 401 included in the production set 400 from the storage unit 206 and generates a preview screen that includes the readout preview images. Then, in step S309, the display control unit 207 displays the preview screen generated in step S308 on the monitor 120.

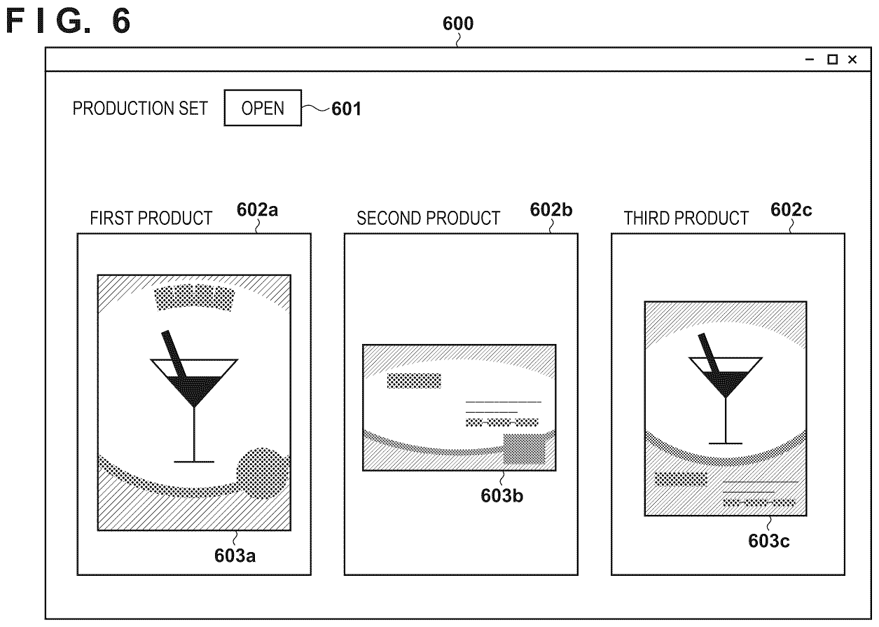

An example of an application screen of the printed color list preview system according to the present embodiment is illustrated in FIG. 6. An application screen 600 of FIG. 6 includes a button 601 and preview screens 602a, 602b, and 602c. Such an application screen is displayed on the monitor 120.

The button 601 is a button for accepting designation of the production set 400 by the user. For example, after the user presses the button 601, designates a path of a folder in which the production set 400 is stored, and then inputs a read instruction, the obtaining unit 201 obtains the production set 400 corresponding to the path.

The preview screen 602a displays a preview image 603a corresponding to the print original set 401a. Further, the preview screen 602b displays a preview image 603b corresponding to the print original set 401b. Further, the preview screen 602c displays a preview image 603c corresponding to the print original set 401c.

In the case of FIG. 6, the display control unit 207 generates the preview screens 602a, 602b, and 602c, generates the application screen 600, which includes the preview screens 602a, 602b, and 602c, and causes the monitor 120 to display the application screen 600.

In this way, in the present embodiment, the designation of a production set is accepted, and preview images are generated in a batch from product original data and print setting data included in the production set and are displayed in a list. This makes it possible to easily confirm a list of printed color simulations of a plurality of pieces of content.

### Modification

When the job issuance apparatus 100 is installed in each of the bases 170a to 170c, a configuration in which the printer and the measurement device are directly connected to the job issuance apparatus 100, and the job issuance apparatus 100 generates a color impression consistency prioritizing profile without going through the control apparatus 110, includes it in a job, and instructs the printer to perform printing may be taken.

Further, a configuration in which the job issuance apparatus 100 issues a job to the control apparatus 110, and the control apparatus 110, which has accepted the job, performs color settings, such as prioritizing color impression consistency with the target color, for the job may be taken. In the case of the configuration in which the control apparatus 110, which has accepted the job, performs color settings, color settings can be performed at least in accordance with the printer and media or the printer type and media type. Alternatively, a configuration in which, when the control apparatus 110, which has accepted the job holds a printer driver (not illustrated) corresponding to each printer, color settings are performed for each printer driver may be taken. Further, a configuration in which an information processing apparatus having functions of both the job issuance apparatus 100 and the control apparatus 110 is provided for each base may be taken.

### Second Embodiment

In each of the following embodiments including the present embodiment, differences from the first embodiment will be described, and unless otherwise mentioned below, it is assumed that the rest is similar to the first embodiment. In the first embodiment, a preview image is generated for all the print original sets 401 included in the production set 400 and displayed in a list. However, a configuration may be taken so as to generate a preview image for only some of the print original sets 401 that have been designated from among the print original sets 401 included in the production set 400 and display them in a list.

Thus, when the number of the print original sets 401 included in the production set 400 is too large to be suitable for preview image list display, or when print original sets 401 that one wants to focus on confirming are determined in advance, it is possible to confirm the printed color simulation result more effectively.

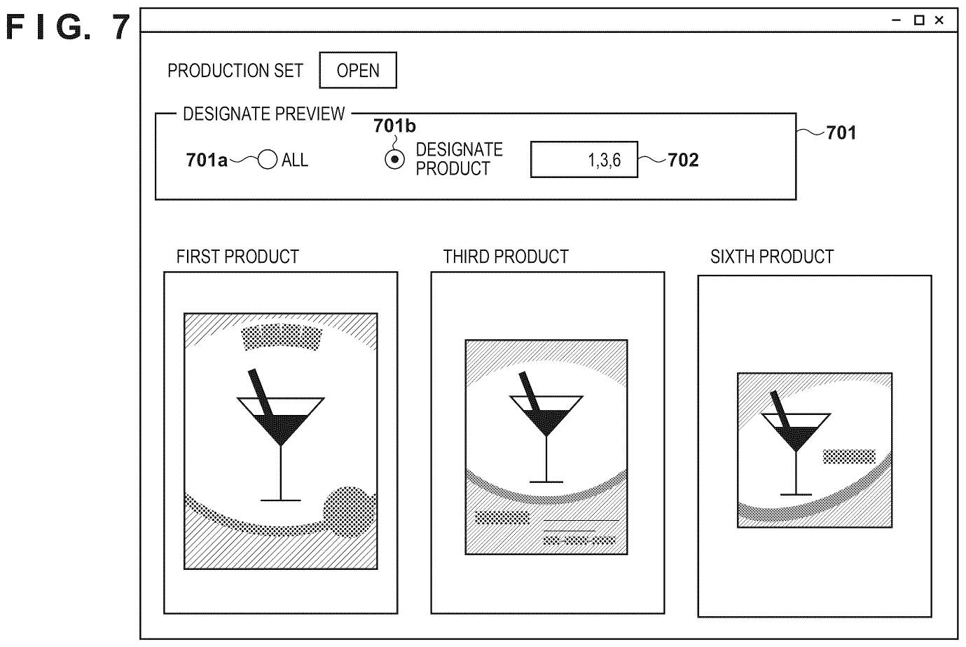

An example of an application screen of the printed color list preview system according to the present embodiment is illustrated in FIG. 7. Similar to the first embodiment, such an application screen is generated by the display control unit 207 and displayed on the monitor 120. The application screen of FIG. 7 is a screen obtained by adding a designation portion 701 for designating a product for which a preview image is to be displayed to the application screen of FIG. 6.

The user need only select a radio button 701a when they want to display a preview image for all the print original sets 401 included in the production set 400. Meanwhile, the user need only select a radio button 701b and input indices of the print original sets 401 that they want to display a preview image for in a box 702 when they want to designate the print original sets 401 that they want to display a preview image for among the print original sets 401 included in the production set 400.

When the radio button 701a is selected, the reading unit 202 obtains all the print original sets 401 included in the production set 400. Meanwhile, when the radio button 701b is selected, the reading unit 202 obtains the print original sets 401 corresponding to the indices inputted in the box 702 among the print original sets 401 included in the production set 400.

In this way, in the present embodiment, it is possible to generate a preview image only for some print original sets, which have been designated, and display them in a list, thereby allowing more effective confirmation of the printed color simulation result.

### Third Embodiment

In the first embodiment, a single production set 400 is designated and previews for that production set 400 are displayed, but a configuration in which a plurality of production sets 400 are accepted and previews for each production set 400 are displayed may be taken. This makes it possible to easily compare production sets 400 with different designs or different target colors and select a better production set 400.

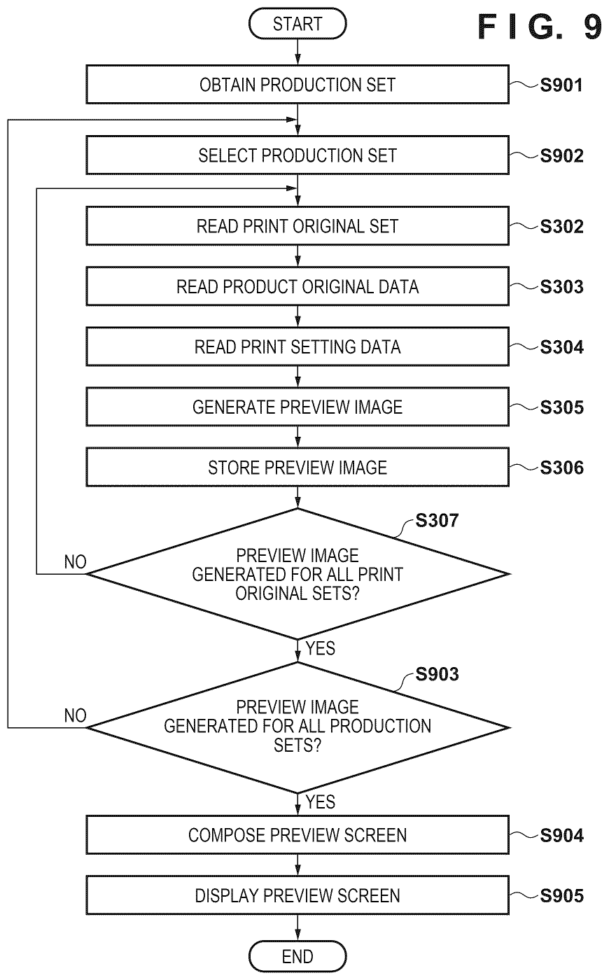

The processing performed by the printed color list preview system in order to generate preview images in which printed colors of each piece of content are simulated and display them in a list when printing a plurality of pieces of content with identical designs in a plurality of different printing systems will be described according to a flowchart of FIG. 9. In FIG. 9, the same processing steps as the processing steps indicated in FIG. 3 are given the same step numbers as those of the processing steps, and the description of those processing steps will be omitted.

In step S901, the obtaining unit 201 obtains a plurality of production sets designated by the user. For example, the obtaining unit 201 obtains a plurality of production sets by repeating the method described in the first embodiment as a method for obtaining one production set by operating the application screen of FIG. 6.

In step S902, the obtaining unit 201 selects one that has not been selected from among the plurality of production sets obtained in step S901 as the selected production set. Then, preview images corresponding to the selected production set are generated by performing the processing of steps S302 to S307 on the selected production set.

In step S903, the obtaining unit 201 determines whether all of the plurality of production sets obtained in step S901 have been selected as the selected production set (preview images have been generated for all of the plurality of production sets obtained in step S901).

As a result of such determination, if all of the plurality of production sets obtained in step S901 have been selected as the selected production set (preview images have been generated for all of the plurality of production sets obtained in step S901), the processing proceeds to step S904.

Meanwhile, if there is a production set that has not been selected as the selected production set among the plurality of production sets obtained in step S901 (there is a production set for which preview images have not been generated among the plurality of production sets obtained in step S901), the processing proceeds to step S902.

In step S904, the display control unit 207 generates an application screen corresponding to the production set for each of the plurality of production sets obtained in step S901.

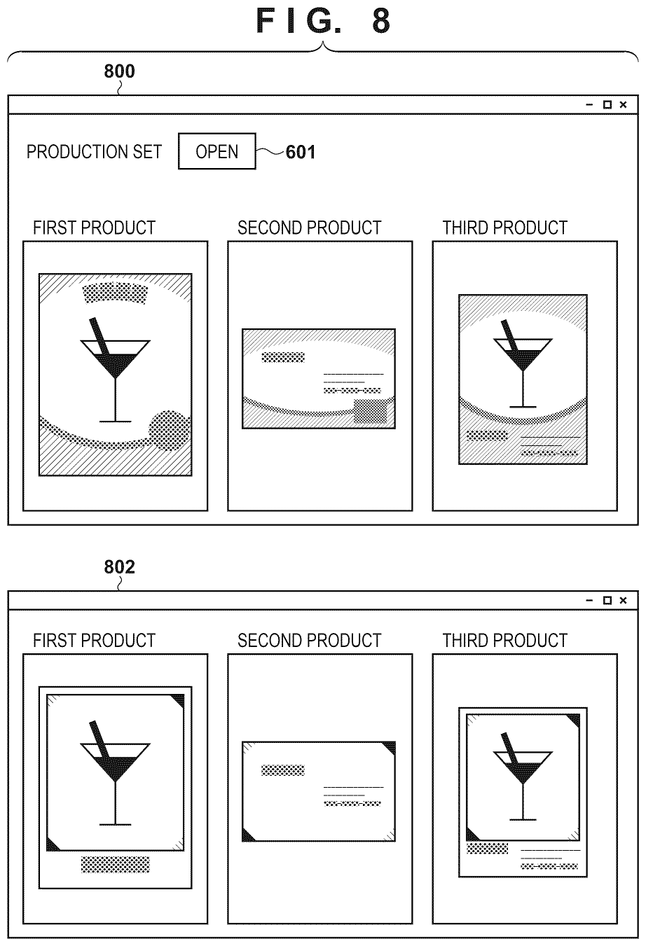

For example, as illustrated in FIG. 8, an application screen 800 is generated for one of the plurality of production sets obtained in step S901 (e.g., the production set selected as the selected production set first), and for other production sets, an application screen 802 in which preview screens generated for each of the other production sets are arranged is generated. In step S905, the display control unit 207 displays the application screens generated in step S904 on the monitor 120.

Thus, in the present embodiment, accepting a plurality of production sets and displaying previews for each production set makes it possible to easily compare production sets with different designs or different target colors and select a better production set.

### Fourth Embodiment

In the present embodiment, an application screen having a function for changing print settings while preview screens are displayed in a list will be described. With such an application screen according to the present embodiment, it is possible to easily confirm print settings with more color impression consistency across a plurality of pieces of content.

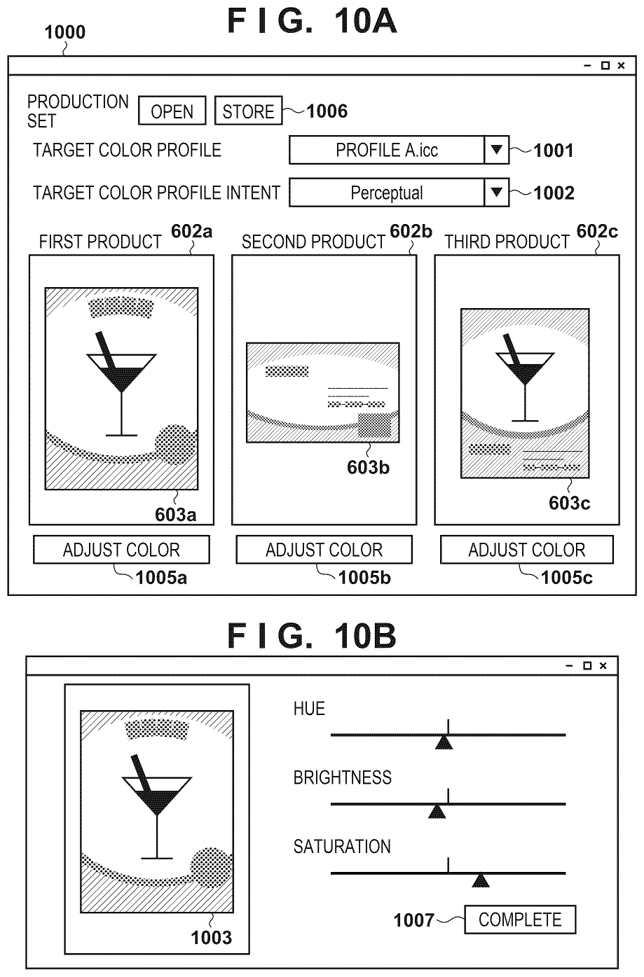

An example of an application screen according to the present embodiment is illustrated in FIG. 10A. Similar to the first embodiment, such an application screen is generated by the display control unit 207 and displayed on the monitor 120. The application screen of FIG. 10A will be described below on differences from the application screen illustrated in FIG. 6. When a common description is given for buttons 1005a, 1005b, 1005c, they will be referred to as the button 1005.

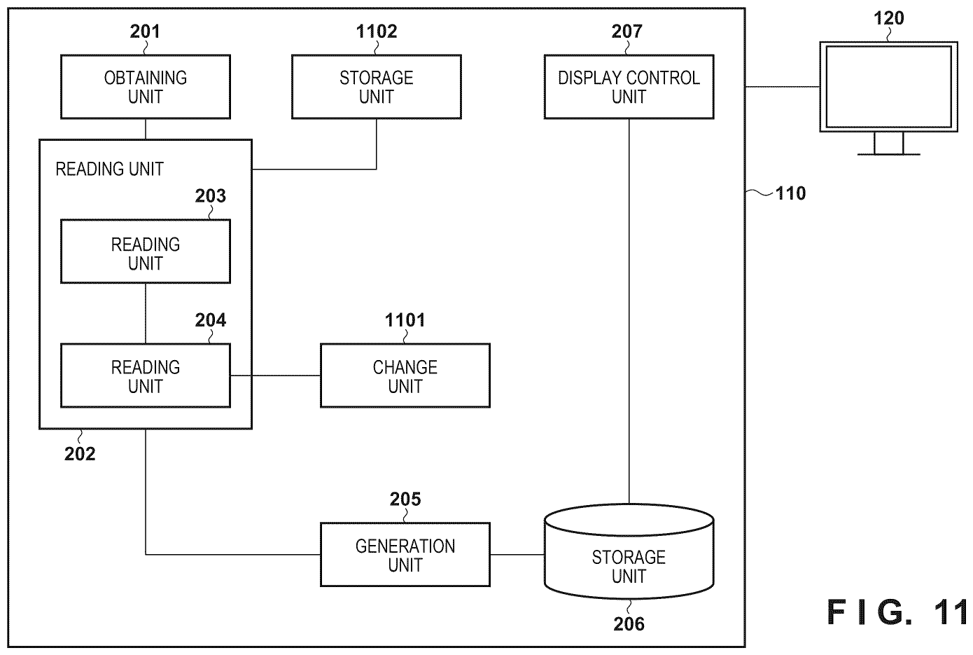

An example of a configuration of a printed color list preview system according to the present embodiment is illustrated in a block diagram of FIG. 11. In FIG. 11, function units similar to the function units illustrated in FIG. 2 are given the same reference numbers as those of the function units, and the description of those function units will be omitted.

When the user operates a widget 1001, a list of target color profiles is displayed, and a change unit 1101 updates (changes) the target color profile 404 to a target color profile designated by the user among the target color profiles displayed in a list.

Further, when the user operates a widget 1002, a list of target color profile intents is displayed, and the change unit 1101 updates (changes) the target color profile intent 405 to a target color profile intent designated by the user among the target color profile intents displayed in a list.

The generation unit 205 performs processing similar to that of the first embodiment by using the changed target color profile 404 and target color profile intent 405 to generate preview images, and stores the generated preview images in the storage unit 206.

A configuration may be such that the target color profile to be changed to is held in advance by the printed color list preview system or is read as an external file designated by the user. Further, a configuration may be taken so as to read a profile of the connected printer.

When the user presses the button 1005, the display control unit 207 displays a color adjustment dialog on the monitor 120. An example of the color adjustment dialog is illustrated in FIG. 10B. In the color adjustment dialog, the adjustment of, for example, hue, brightness, saturation, and the like can be performed on the preview image 603. That is, the user can adjust the hue of the preview image 603 by operating a slider corresponding to hue left and right, the user can adjust the brightness of the preview image 603 by operating a slider corresponding to brightness left and right, and the user can adjust the saturation of the preview image 603 by operating a slider corresponding to saturation left and right.

When the user presses a button 1007, the change unit 1101 updates the print setting data 403 with the contents of the operation (adjusted values for hue, brightness, saturation, etc.) performed by the user in the color adjustment dialog. Here, the change unit 1101 may update the printer profile 406 or may update the printer settings 407.

Further, when the user presses a button 1006, the change unit 1101 stores the production set 400 including the updated print setting data 403 in the storage unit 1102.

Thus, in the present embodiment, providing an application screen having a function for changing print settings while preview screens are displayed in a list makes it possible to easily confirm print settings with more color impression consistency.

### Fifth Embodiment

In the present embodiment, an application screen having a function for adjusting the target color while preview screens are displayed in a list will be described. With such an application screen according to the present embodiment, it is possible to easily adjust, while confirming, levels of individual optimization and consistency across products in content printing in which a plurality of devices and media are used.

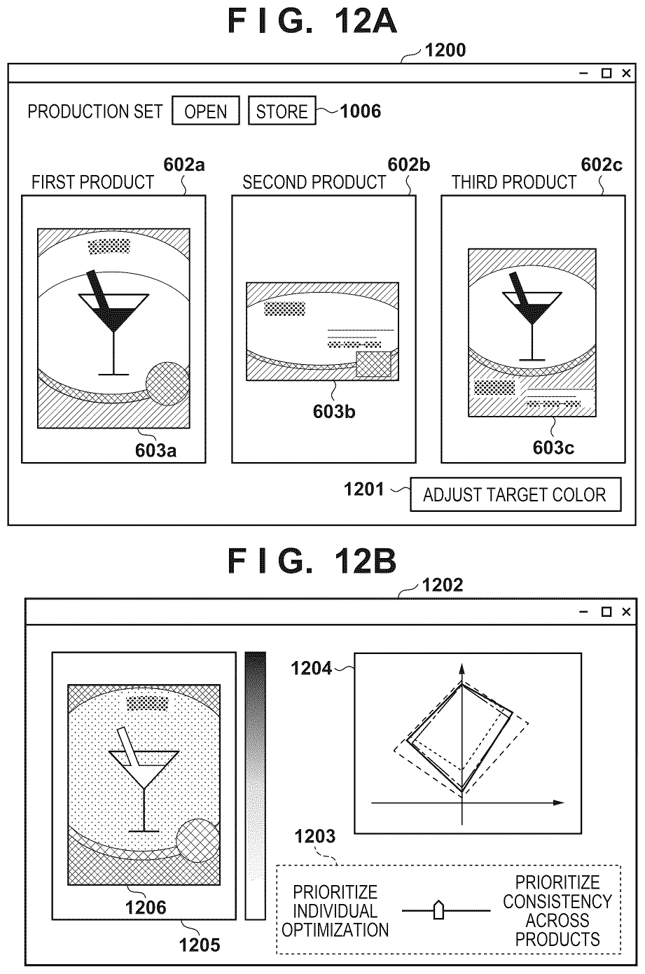

An example of an application screen 1200 according to the present embodiment is illustrated in FIG. 12A. Similar to the first embodiment, such an application screen 1200 is generated by the display control unit 207 and displayed on the monitor 120. The application screens of FIGS. 12A and 12B will be described below on differences from the application screens illustrated in FIG. 6 and FIG. 10.

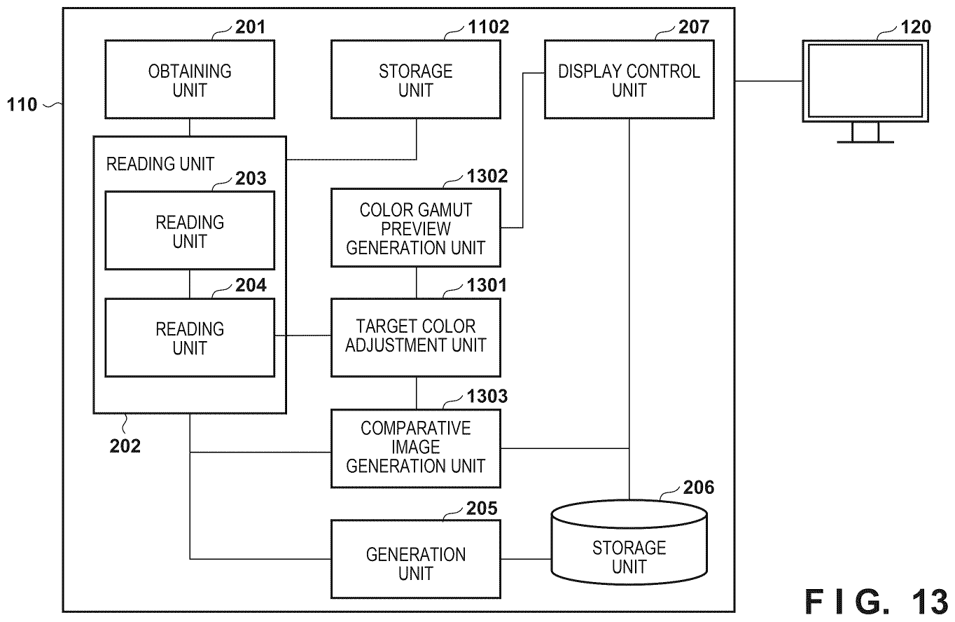

An example of a configuration of a printed color list preview system according to the present embodiment is illustrated in a block diagram of FIG. 13. In FIG. 13, function units similar to the function units illustrated in FIGS. 2 and 11 are given the same reference numbers as those of the function units, and the description of those function units will be omitted.

When a target color adjustment button 1201 is pressed in accordance with a user operation, the display control unit 207 displays a target color adjustment dialog screen 1202 on the monitor 120. FIG. 12B is a diagram illustrating an example of the target color adjustment dialog screen 1202. The target color adjustment dialog screen 1202 includes a target color adjustment widget 1203.

When the target color adjustment widget 1203 is operated in accordance with a user operation, a target color adjustment unit 1301 obtains a printer profile and a target color profile of the print setting data from the reading unit 202 and adjusts the target color.

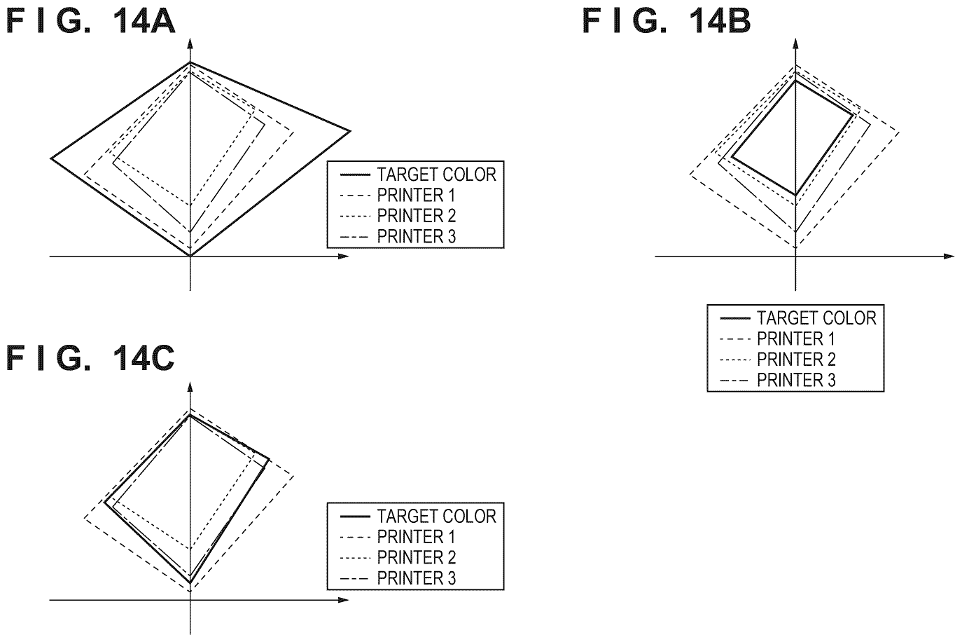

FIGS. 14A to 14C are schematic diagrams illustrating a target color and color gamuts of printers and adjustment of the target color. FIG. 14A illustrates a relationship between the target color and printer color gamuts when the level of individual optimization is maximum. When the target color encompasses all of the printers 1 to 3, color space is mapped so as to fully use each printer's entire color gamut, and so, the level of individual optimization will be maximum in each printer. Here, printers 1 to 3 each represent the printer color gamut of the first to third productions.

FIG. 14B illustrates a relationship between the target color and printer color gamuts when the level of consistency across products is maximum. When the target color is encompassed in all of the printers 1 to 3, that is, encompassed in a common portion of the printers 1 to 3, the target color is reproducible in each printer, and so, the level of consistency across products will be maximum.

FIG. 14C is a diagram illustrating an example of adjusted target colors. The target color adjustment unit 1301 adjusts the size of the target color gamut between the maximum level of individual optimization to the maximum level of consistency across products based on the designation in the target color adjustment widget 1203. Here, the target color may be adjusted by selecting an appropriate one from preset target colors prepared in advance, or may be newly generated by geometric deformation or the like from a target color serving as a reference.

When the user presses the button 1006, the target color adjustment unit 1301 reflects the adjusted target color in the target color profile 404 of the print setting data 403 and stores the production set 400 including the print setting data 403 in the storage unit 1102. Further, as illustrated in FIG. 12B, the target color adjustment dialog screen 1202 may include a color gamut preview display portion 1204 and a comparative image display portion 1205.

A color gamut preview generation unit 1302 obtains a target color adjusted from the target color adjustment unit 1301 and color gamut information of printers and generates a color gamut preview image. Next, the display control unit 207 displays the color gamut preview image in the color gamut preview display portion 1204.

The comparative image generation unit 1303 obtains the adjusted target color from the target color adjustment unit and generates a comparative image 1206. For example, the comparative image 1206 is a color difference image in the L*a*b* 505, which is obtained by performing processing similar to that of the first embodiment on the product original data a of a first product based on the print setting data 403a of the first product and the print setting data 403b of the second product and may be a saturation difference image between saturation images obtained based on the L*a*b* 505. Next, the display control unit 207 displays the comparative image 1206 on the comparative image display portion 1205.

Thus, in the present embodiment, providing an application screen having a function for adjusting the target color while preview screens are displayed in a list makes it possible to easily adjust, while confirming, the levels of individual optimization and consistency across products.

### Sixth Embodiment

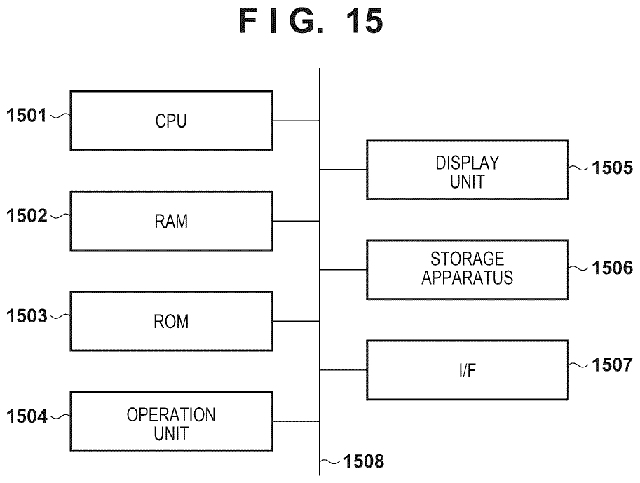

The respective function units illustrated in FIGS. 2, 11, and 13 (excluding the storage units 206 and 1102) may be implemented in hardware or software (computer program). In the latter case, a computer apparatus capable of executing such a computer program is applicable to the control apparatus 110. An example of a hardware configuration of a computer apparatus applicable to the control apparatus 110 will be described with reference to a block diagram of FIG. 15.

A CPU 1501 executes various processes using computer programs and data stored in a RAM 1502. The CPU 1501 thus performs control of operation of the entire computer apparatus and executes or controls various processes described as processes to be performed by the control apparatus 110.

The RAM 1502 includes an area for storing computer programs and data loaded from a ROM 1503 and a storage apparatus 1506 and an area for storing computer programs and data received from an external apparatus via an I/F 1507. Further, the RAM 1502 includes a work area that the CPU 1501 uses when executing various processes. The RAM 1502 can thus provide various areas as appropriate.

The ROM 1503 stores setting data of the computer apparatus, computer programs and data related to startup of the computer apparatus, computer programs and data related to a basic operation of the computer apparatus, and the like.

An operation unit 1504 is a user interface, such as a keyboard, a mouse, and a touch panel screen, and can input various kinds of instructions and information to the computer apparatus by being operated by a user. For example, the user can perform the above user operations by operating the operation unit 1504.

The display unit 1505 includes a liquid crystal screen or a touch panel screen and can display a result of processing by the CPU 1501 by using images, characters, and the like. For example, the display unit 1505 can be used as the above monitor 120. The display unit 1505 may be a projection apparatus such as a projector for projecting images and characters.

The storage apparatus 1506 is a non-volatile memory, and the storage apparatus 1506 stores an OS, computer programs and data for causing the CPU 1501 to execute or control various processes described as processes to be performed by the control apparatus 110, and the like. The above storage units 206 and 1102 can be implemented using the RAM 1502 or the storage apparatus 1506.

The I/F 1507 functions as an interface for performing data communication with an external apparatus via, for example, a network, such as a LAN or the Internet. For example, the computer apparatus performs data communication with apparatuses, such as the job issuance apparatus 100, the measurement device 150, and the printers 130a, 130b, and 130c, via the I/F 1507.

The CPU 1501, the RAM 1502, the ROM 1503, the operation unit 1504, the display unit 1505, the storage apparatus 1506, and the I/F 1507 are all connected to a system bus 1508. The configuration illustrated in FIG. 15 is only one example of a hardware configuration of a computer apparatus applicable to the control apparatus 110, and can be appropriately changed or modified.

Further, the configuration and the method of operating UI screens such as the application screen used in the above embodiments are examples and are not limited to a particular configuration and operation method as long as similar functions can be achieved by the configuration and the operation method.

The numerical values, processing timing, processing order, processing performer, data (information) configuration/obtainment method/transmission destination/transmission source/storage location, and the like used in the above embodiments and modifications have been given as examples for the sake of providing a concrete explanation, and the present invention is not intended to be limited to such examples.

Further, some or all of the embodiments and modifications described above may be appropriately combined and used. Further, some or all of the embodiments and modifications described above may be selectively used.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-155134, filed Sep. 9, 2024 and Japanese Patent Application No. 2024-196927, filed Nov. 11, 2024 which are hereby incorporated by reference herein in their entirety.

What is claimed is:

1. An information processing apparatus comprising:
an obtaining unit configured to obtain a production set that includes a plurality of print targets and print settings for the print targets;
a generation unit configured to generate a preview image for each print target in the production set based on print settings for that print target; and
a display control unit configured to cause preview images generated by the generation unit to be displayed in a list.

2. The information processing apparatus according to claim 1, wherein
the generation unit configured to generate a preview image of a print target based on a profile of a printing apparatus configured to print the print target and a setting for a target color.

3. The information processing apparatus according to claim 2, wherein
the setting for the target color is common across sets, each including the print target and the print settings for the print target.

4. The information processing apparatus according to claim 2, further comprising:
a change unit configured to change the setting for the target color in accordance with a user operation.

5. The information processing apparatus according to claim 1, wherein
the print targets are print targets to be printed as respective commercial materials among collaterals.

6. The information processing apparatus according to claim 1, wherein
the display control unit causes preview images of all the print targets included in the production set to be displayed in a list.

7. The information processing apparatus according to claim 1, wherein
the display control unit causes preview images of print targets designated in accordance with a user operation to be displayed in a list among the print targets included in the production set.

8. The information processing apparatus according to claim 1, wherein
the obtaining unit obtains a plurality of production sets;
the generation unit generates preview images for each production set obtained by the obtaining unit; and
the display control unit causes the preview images of each production set generated by the generation unit to be displayed.

9. The information processing apparatus according to claim 8, wherein
the display control unit causes, for each production set, preview images of that production set to be displayed in a list in a different screen.

10. The information processing apparatus according to claim 1, further comprising:
an adjustment unit configured to adjust colors of the preview image.

11. The information processing apparatus according to claim 2, wherein
the target color is adjusted in accordance with a user operation.

12. The information processing apparatus according to claim 11, wherein
adjustment of the target color involves
adjusting a size and a shape of the target color based on color gamut information of the printing apparatus.

13. The information processing apparatus according to claim 11, wherein
a preview screen indicating color gamut sizes of the target color and the printing apparatus is displayed.

14. The information processing apparatus according to claim 11, wherein
an image indicating a difference between preview images for preview images of a plurality of printing apparatuses is displayed.

15. An information processing method performed by an information processing apparatus, the method comprising:
obtaining a production set that includes a plurality of print targets and print settings for the print targets;
generating a preview image for each print target in the production set based on print settings for that print target; and
causing the preview image generated for each print target to be displayed in a list.

16. A non-transitory computer-readable storage medium storing a computer program for causing a computer to function as:
an obtaining unit configured to obtain a production set that includes a plurality of print targets and print settings for the print targets;
a generation unit configured to generate a preview image for each print target in the production set based on print settings for that print target; and
a display control unit configured to cause preview images generated by the generation unit to be displayed in a list.
